(19) United States
(12) Patent Application Publication
(10) Pub. No.: US 2016/0044384 A1
(43) Pub. Date: Feb. 11, 2016

(54) OPERATING A TERMINAL DEVICE IN A COMMUNICATION SYSTEM

(71) Applicants: Anders Edenbrandt, Lund (SE); Anders Isberg, Akarp (SE)

(72) Inventors: Anders Edenbrandt, Lund (SE); Anders Isberg, Akarp (SE)

(21) Appl. No.: 14/361,870

(22) PCT Filed: Apr. 30, 2013
(86) PCT No.: PCT/EP2013/058954

§ 371 Date: May 30, 2014

(51) Int. Cl. H04N 21/647; H04N 5/44; H04N 5/232; H04L 29/06; H04N 21/233

(52) U.S. Cl. CPC H04N 21/64738; H04L 65/1059; H04L 65/4092; H04L 65/80; H04N 21/2335; H04N 5/23245; H04N 5/44

(57) ABSTRACT

The present invention relates to a method for operating a terminal device (10) of a communication system. The terminal device (10) comprises a capturing device (13, 14) for capturing media. The terminal device (10) is configured to transmit the captured media via a data communication connection (50-52) of the communication system. According to the method, a transmission quality of the data communication connection (50-52) is determined and a capturing quality of the capturing device (13, 14) is automatically set depending on the determined transmission quality.

### FIELD OF THE INVENTION

The present invention relates to a method for operating a terminal device of a communication system, especially to a method for reducing a power consumption of a mobile, battery-powered terminal device in a communication system during media streaming. The present invention relates furthermore to a terminal device, for example a cellular phone, implementing the method.

### BACKGROUND OF THE INVENTION

Increasing capabilities of wireless communication systems, for example telecommunication networks based on GSM, UMTS or LTE, enable real-time data communication utilizing new ways for application developers to build applications that are utilizing media streaming, for example, video streaming or audio streaming. For example, applications running on terminal devices may capture media streams and send them over the communication system including for example a communication via the internet, using peer-to-peer connections without using proprietary technologies. However, this use case is also one of the most demanding use cases in terms of power consumption. For example, latency and real-time characteristics are essential to media streaming and therefore most subsystems of the terminal device have to be operated actively and may not be brought down into a low-power mode. Furthermore, a display screen may be activated and also a transceiver unit for enabling radio frequency communication may be activated during media streaming. Finally, a media capturing device, for example a camera or a microphone, as well as corresponding video and audio encoders and decoders may be active during media streaming. Especially, video encoding and decoding may require a considerable amount of electrical energy.

Conventionally, media streaming applications use a real time transport protocol (RTP) to send media streams for example over a user data protocol and internet protocol (UDP/IP). On the receiver side there is a function that estimates essential parameters, like the available bandwidth, packed loss and roundtrip time. These parameters give an approximation of the quality of the communication channel. These parameters may be reported back from the receiver to the sender using a real-time control protocol (RTCP), and the sender can continuously take the communication quality into consideration when encoding the media. Thus, a power consumption for encoding and decoding video streams in the terminal devices may be reduced.

However, there is still a need for an even more improved operation of terminal devices, especially battery-powered terminal devices, in a communication system for reducing power consumption of the terminal devices.

### SUMMARY OF THE INVENTION

According to the present invention, this object is achieved by a method for operating a terminal device of a communication system as defined in claim 1, a method for operating a terminal device of a communication system as defined in claim 3, a terminal device for a communication system as defined in claim 11, a terminal device for a communication system as defined in claim 12, and a terminal device for a communication system as defined in claim 14. The dependent claims define preferred and advantageous embodiments of the invention.

According to an aspect of the present invention, a method for operating a terminal device of the communication system is provided. The terminal device may comprise in particular a battery-powered terminal device, for example mobile terminal device, like a mobile phone or a so-called smartphone. The terminal device comprises a capturing device for capturing media, for example audio and/or video media. Furthermore, the terminal device is configured to transmit the captured media via a data communication connection established via the communication system. According to the method, a transmission quality of the data communication connection is determined. The transmission quality may be determined by the terminal device itself by monitoring received data or may be determined by a further terminal device to which the terminal device is sending the captured media, wherein the further terminal device determines the transmission quality by monitoring the received data and by sending back the determined transmission quality to the terminal device. The transmission quality may be transmitted via a so-called real-time control protocol (RTCP) of the communication system. Based on the determined transmission quality the terminal device automatically sets or configures a capturing quality of the capturing device. In other words, according to the method of the present invention, the quality of a communication channel is used at the sender side to control how the media capturing is done. For example, there is no need for a camera to capture video frames with a high frame rate and high resolution if the bandwidth of the communication channel is low. In contras to conventional implementations where for example a camera captures media with a fixed frame rate and resolution and an encoder then has the responsibility to adjust the encoding based on the measured quality of the communication channel, changing the quality at already the source, for example the camera, will safe power in the camera system and will additionally reduce the load on the encoder since the amount of data going into the encoder is reduced. Thus, power consumption during media streaming can be significantly reduced. The reduced power consumption may result in a longer operating time especially in case of a battery-powered terminal device.

According to an embodiment, the transmission quality of the communication channel established for transmitting the captured media stream comprises at least one of a group consisting of a bandwidth, a data rate, a bit error rate, a packet loss rate, a jitter and/or a data roundtrip time of the data communication connection. For example, based on the bandwidth, the data rate and transmission failures like the bit error rate and the packet loss rate, an actual transmission capacity may be determined and used for setting a capturing quality of the capturing device. When the achievable actual transmission capacity decreases, capturing parameters of the capturing device, for example a frame rate of a camera may be reduced and thus power consumption for processing information from the camera as well as for coding the video information may be reduced.

According to a further aspect of the present invention, a method for operating a terminal device of a communication system is provided. The terminal device comprises a capturing device for capturing media and a media coding device for coding the captured media. The terminal device is adapted to transmit the coded media via a data communication connection established via the communication system to a further terminal device of the communication system. According to the method, the terminal device receives environmental information from the further terminal device. The environmental information relates to an environmental condition in an environment of the further terminal device. Based on the received environmental information, the terminal device automatically sets a coding parameter of the media coding device. The environmental information may be received via a real-time control protocol (RTCP) established between the terminal device and the further terminal device. In other words, when a sending terminal device is capturing media and sends this captured media to a receiving terminal device, the real-time control protocol established between the two terminal devices shall be extended to optionally provide information from a local sensor of the receiving terminal device. The environmental information from the local sensors may comprise for example background noise from a microphone of the receiving terminal device or light conditions from corresponding sensors of the receiving terminal device. The sending terminal device receives this information via the real-time control protocol. In the sending terminal device, this information may be used to configure or control a media coding device, for example an video encoder, to optimize the content for the target environment at the receiving terminal device. For example, if the receiving terminal device is in a dark environment, for example in a dark room, the intensity or strength of colors of a captured video stream may be reduced already at the sending terminal device.

According to an embodiment, the environmental information comprises a background noise level at the further terminal device. The background noise level may be determined at the further terminal device via a microphone of the further terminal device. Based on the background noise level a coding quality of an audio encoder may be configured. Additionally or as an alternative, the environmental information comprises a light intensity level at the further terminal device. The light intensity level may be determined at the further terminal device via a camera of the further terminal device or a light sensitive sensor. The light intensity level may be communicated via the real-time control protocol to the sending terminal device and may be used at the sending terminal device to configure a coding device which encodes a video stream captured at the terminal device. For example, when the further terminal device is in a dark environment, a contrast, a brightness or a color resolution may be reduced during video stream encoding. Furthermore, when the environmental information indicates that the further terminal device is operated in a bright environment, a brightness and a contrast of the video stream may be increased by a corresponding coding. In this manner, a video and audio streaming may be adapted to the needs of the receiving terminal device and therefore a power consumption at the sending terminal device and/or at the receiving terminal device may be reduced.

According to an embodiment, additionally the capturing quality of the capturing device of the sending terminal device is configured automatically depending on the received environmental information. For example, when the receiving terminal device is operated in a noisy environment which is indicated by the background noise level sent back to the sending terminal device via the real-time control protocol, a sampling rate or a sampling accuracy of an audio signal to be streamed from the sending terminal device to the receiving terminal device may be reduced. The sampling rate may indicate the number of samples taken per second from the electrical signal provided by a microphone. The sampling accuracy may define the number of bits used for each sample. By reducing the sampling rate and the sampling accuracy already during a conversion from the analogue signal from the microphone into a digital signal, electrical energy may be saved at the analogue to digital converter as well as in the coding device used for encoding the digitalized audio signal.

According to a further embodiment, the capturing device comprises a camera and setting the capturing quality of the capturing device comprises setting a pixel resolution, setting a frame rate, setting a color depth and/or setting a contrast of the camera. Varying these parameters of the camera may result in a reduced power consumption of the camera itself as well as a reduced power consumption of a coding device used for encoding the information from the camera. A pixel resolution defines the number of pixels which form an image or frame captured by the camera. The pixel resolution may be varied from a few hundred thousand pixels to a few megapixels. The frame rate of the camera defines the number of frames or images taken per second for composing a moving image video. The frame rate may be varied from a few frames per second, for example 2 to 5 or 10 frames per second up to 25, 50 or even 100 frames per second. The color depth may be defined as a number of bits per color and pixels. For example, the color depth may be varied from 8 to 36 bit per pixel.

The capturing device may comprise a plurality of cameras for taking three dimensional videos. The capturing quality may comprise setting a number of cameras for taking the three dimensional video, or setting, if a two dimensional or a three dimensional video is taken.

According to a further embodiment, the capturing device comprises at least one microphone or a plurality of microphones. The plurality of microphones may be used for receiving stereo or surround sound. Setting the capturing quality of the capturing device comprises for example setting a sampling rate of an audio signal provided by each of the microphones or by setting a sampling accuracy of the audio signal provided by each of the microphones. The sampling rate defines the number of samples per second. Each sample comprises a digital value of the audio signal at the point in time of sampling. The sampling rate may be varied from a few samples per second, for example 500 to 1000 samples per second, up to 22000 or 44000 samples per second. The sampling accuracy defines the number of bits used for representing the digital value of each sample. The sample accuracy may be varied in the range of 8 to 32 bits per sample. Furthermore, when setting the capturing quality of the capturing device, the number of used audio channels may be configured. For example, when the quality of the data communication connection is poor, only one audio channel may be captured and encoded, whereas when the transmission quality of the data communication connection is very high, two or even more audio channels may be used for streaming audio data.

According to a further aspect of the present invention, a terminal device for a communication system is provided. The terminal device comprises a transceiver unit for establishing a data communication connection. The terminal device comprises furthermore a capturing device for capturing media, for example a microphone and/or a camera. The terminal device comprises furthermore a processing unit configured to determine a transmission quality of the data communication connection between the terminal device and a further terminal device. Depending on the determined transmission quality, the processing unit automatically sets a capturing quality of the capturing device and transmits the captured media via the data communication connection. Thus, depending on the transmission quality, the capturing quality may be increased or reduced which may effect the power consumption of the capturing device. Therefore, electrical power for powering the capturing device may be saved.

According to a further aspect of the present invention, a terminal device for a communication system is provided. The terminal device comprises a transceiver unit for establishing a data communication connection, a capturing device for capturing media, for example capturing audible information in an environment of the terminal device and/or visible information in an environment of the terminal device, and a media coding device for coding the captured media. The terminal device comprises furthermore a processing unit configured to transmit the coded media via the data communication connection to a further terminal device of the communication system. The processing unit is furthermore adapted to receive environmental information from the further terminal device. The environmental information relates to an environmental condition in an environment of the further terminal device, for example a background noise level or an illumination level in an environment of the further terminal device. Depending on the received environmental information, the processing unit automatically sets a coding parameter of the media coding device. Thus, the captured media information may be adequately coded for the receiver which may result in a reduced power consumption at the sending terminal device as well as at the receiving terminal device.

According to a further aspect of the present invention, a terminal device for a communication system is provided which comprises a transceiver unit for establishing a data communication connection, a media playback device for playing back media, and a sensor for capturing environmental information relating to an environmental condition in a environment of the terminal device. The terminal device comprises furthermore a processing unit configured to receive media to be played back via the data communication connection and to play back the received media. Furthermore, the processing unit is configured to capture or sense the environmental information in the environment of the terminal device with the sensor and to transmit the environmental information via a real-time control protocol to another terminal device of the communication system from which the media to be played back is received. The environmental information sent via the real-time control protocol to the other terminal device may be used in the other terminal device for setting a coding parameter of a media coding device of the other terminal device. Therefore, a power consumption of the terminal device and of the other terminal device may be reduced, as the media coding can be configured appropriately with respect to the environment where the media is to be played back.

According to an embodiment, the terminal devices described above are configured to perform the above-described methods and embodiments. Furthermore, the terminal devices may comprise a portable battery-powered device, for example a mobile phone, a personal digital assistant, a mobile music player, a tablet computer, a laptop computer, a notebook computer or a navigation system.

Although specific features described in the above summary and the following detailed description are described in connection with specific embodiments and aspects of the present invention, it should be understood that the features of the embodiments and aspects may be combined with each other unless specifically noted otherwise.

### BRIEF DESCRIPTION OF THE DRAWINGS

The present invention will now be described in more detail with reference to the accompanying drawings.

FIG. 1 shows a terminal device in a communication system according to an embodiment of the present invention.

FIG. 2 shows a terminal device according to another embodiment of the present invention.

FIG. 3 shows a flowchart comprising steps of a method for operating a terminal device according to an embodiment of the present invention.

### DETAILED DESCRIPTION OF PREFERRED EMBODIMENTS

In the following, exemplary embodiments of the invention will be described in more detail. It has to be understood that the features of the various exemplary embodiments described herein may be combined with each other unless specifically noted otherwise. Same reference signs in the various drawings refer to similar or identical components.

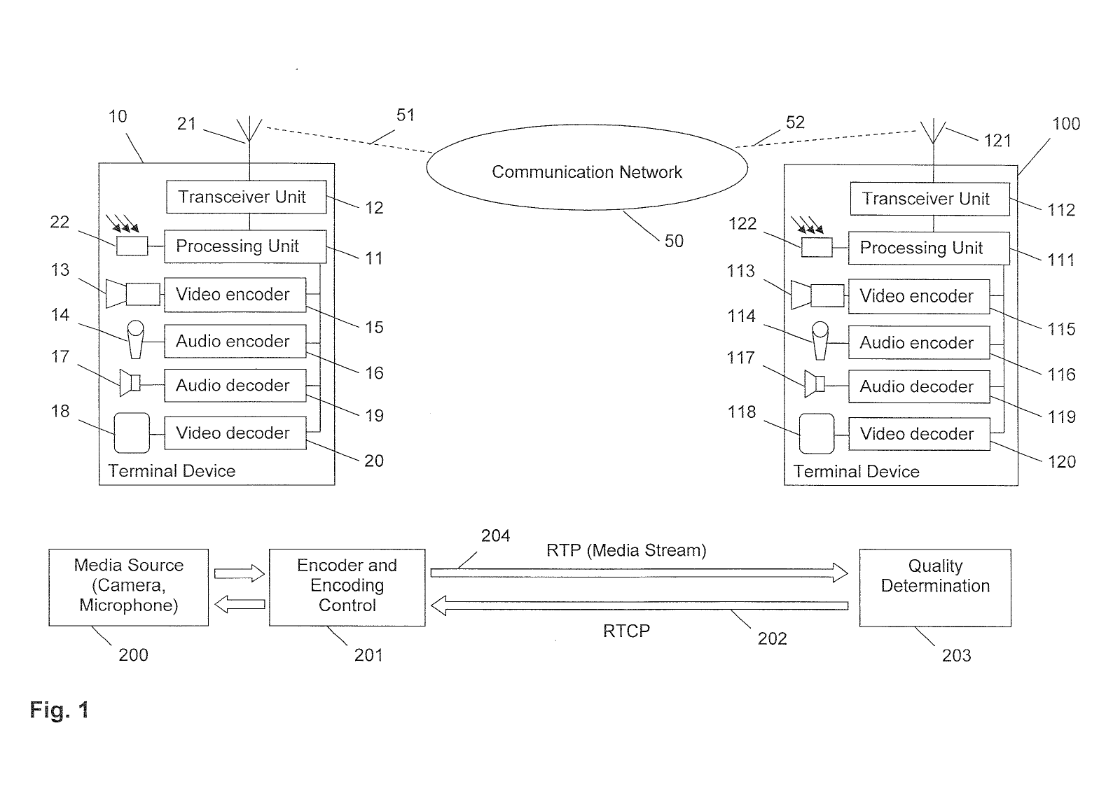

FIG. 1 shows a communication system comprising a first terminal device 10 and a second terminal device 100 which are coupled via a communication network 50. The first terminal device 10 is coupled via a radio frequency connection 51 to the communication network 50 and the second terminal device 100 is coupled via a radio frequency connection 51 to the communication network 50. The communication network 50 may comprise a telephone communication network based on GSM, UMTS or LTE and a data communication network, for example the World Wide Web or internet. Furthermore, the communication network 50 may comprise any other kind of communication network, for example a wireless local area network WLAN.

The communication connections 51, 52 and the communication network 50 may be configured to establish a data communication connection between the first terminal device 10 and the second terminal device 100. The data communication connection may be adapted to communicate speech data as well as any other kind of media data in a bi-directional way between the first terminal device 10 and the second terminal device 100. The terminal devices 10, 100 may comprise for example mobile phones, especially so-called smartphones. However, the terminal devices 10, 100 may comprise any other kind of mobile or stationary terminal device.

The structure of the terminal devices 10, 100 will be described in more detail in the following with respect to terminal device 10. The terminal device 100 may have the same structure as the terminal device 10 shown in FIG. 1. However, to support a unique identification of components located in either the first terminal device 10 or in the second terminal device 100, the components are designated with different reference signs. However, components of the second terminal device 100 which correspond to components of the first terminal device 10 are indicated by a reference sign which has an offset of 100 compared to the reference sign used in connection with the first terminal device 10. Therefore, the description of the structure of the first terminal device 10 is valid in the same way for the second terminal device 100 and will therefore not be repeated.

The first terminal device 10 comprises a processing unit 11, for example a microprocessor. Furthermore, the terminal device 10 comprises a transceiver unit 12 coupled to the processing unit 11 and to an antenna 21 for setting up a data communication connection 51 to the communication network 50 and to other terminal devices. The terminal device 10 comprises media input and output devices which comprise for example a camera 13 for taking digital videos of an environment of the terminal device 10, a microphone 14 for capturing sounds and audio signals in an environment of the terminal device 10, a loudspeaker 17 for outputting audio information to a user of the terminal device 10 and a display screen 18 for outputting visual information, for example graphical information, images and videos. The terminal device 10 may comprise further input and output devices, for example a touch-sensitive surface mounted on the display 18 for providing a touch-sensitive user interface and operating elements, for example push keys or other switches. Furthermore, the terminal device 10 comprises a light sensitive sensor 22 configured to measure a brightness in an environment of the terminal device 10, for example for adjusting a brightness of the display 18 and for other purposes as will be described in the following. The camera 13 is coupled to a video encoder 15 which is configured to encode video and image data provided by the camera 13 according to an encoding algorithm, for example a video encoding standard, like MPEG4. The microphone 14 is coupled to an audio encoder 16 which provides encoded audio data based on the audio signal received from the microphone 14. For outputting audio data an audio decoder 19 is coupled to the loudspeaker 17 and for outputting video data or image data, a video decoder 20 is coupled to the display 18. The encoders 15, 16 and the decoders 19, 20 or coupled to the processing unit and may be provided with data received by the transceiver unit 12 or may provide data to be output by the transceiver unit 12.

The above-described configuration of the communication system comprising the terminal devices 10, 100 and the communication network 50 enables applications where a user of the terminal device 10 is capturing audio and video data and streaming this audio and video data via the communication network to another user using the terminal device 100, where the audio and video data is output to the user. Transmitting audio and video information from one terminal device to another terminal device in real-time is also called media streaming. Such a media streaming from the terminal device 10 to the terminal 100 will be described in the following in more detail in connection with FIG. 1. In the following, a unidirectional media streaming will be described, in which the media is streamed from terminal device 10 to terminal device 100. However, the media streaming may be performed in the other direction at another time or at the same time. As the media is streamed from terminal device 10 to terminal device 100, in the following, terminal device 10 will be called the sending terminal device and terminal device 100 will be called the receiving terminal device.

In the sending terminal device 10, a media source 200, for example the camera 13 or the microphone 14, provides media information to an encoder 201, for example the video encoder 15 and the audio encoder 16. The information from the encoder 201 is sent as a media stream via for example a real-time protocol (RTP) 204 to the receiving terminal device 100. A quality determination 203 in the receiving terminal device 100 determines a quality of the data communication connection of the media stream 204. The quality determination 203 may comprise for example monitoring a bandwidth, a data rate, a bit error rate, a packet loss rate, a jitter and a data roundtrip time of the data communication connection. The determined quality is reported to the sending terminal device 10 via for example a real-time control protocol (RTCP) 202. An encoding control 201 in the receiving terminal device 10 may use the determined transmission quality of the data communication for adjusting a coding scheme and may furthermore forward this transmission quality for adjusting the capturing quality of the media source 200. For example, a pixel resolution, a frame rate, a color depth or a contrast of the camera 13 may be adjusted and a sampling rate and a sampling accuracy of an analogue to digital converter between the microphone 14 and the audio encoder 16 may be adjusted based on the received transmission quality. Thus, when the transmission quality of the data communication connection is poor, the capturing quality of the camera 13 and the microphone 14 may be reduced which may save electrical power in the camera and the analogue to digital converter of the microphone as well as electrical power in the video encoder 15 and the audio encoder 16.

The communication in the lower part of FIG. 1 only describes a one-way communication channel whilst the devices 10 and 100 are described as two way communication devices with encoders as well as decoders. The typical use case may be a bidirectional communication although even a one way communication (unidirectional) channel is a valid configuration. Therefore, although not shown in FIG. 1, there may be two RTP/RTCP communication channels in case of a bidirectional communication, i.e. a further RTP Media Stream in an opposite direction to RTP 204 and a further RTCP in an opposite direction to RTCP 202.

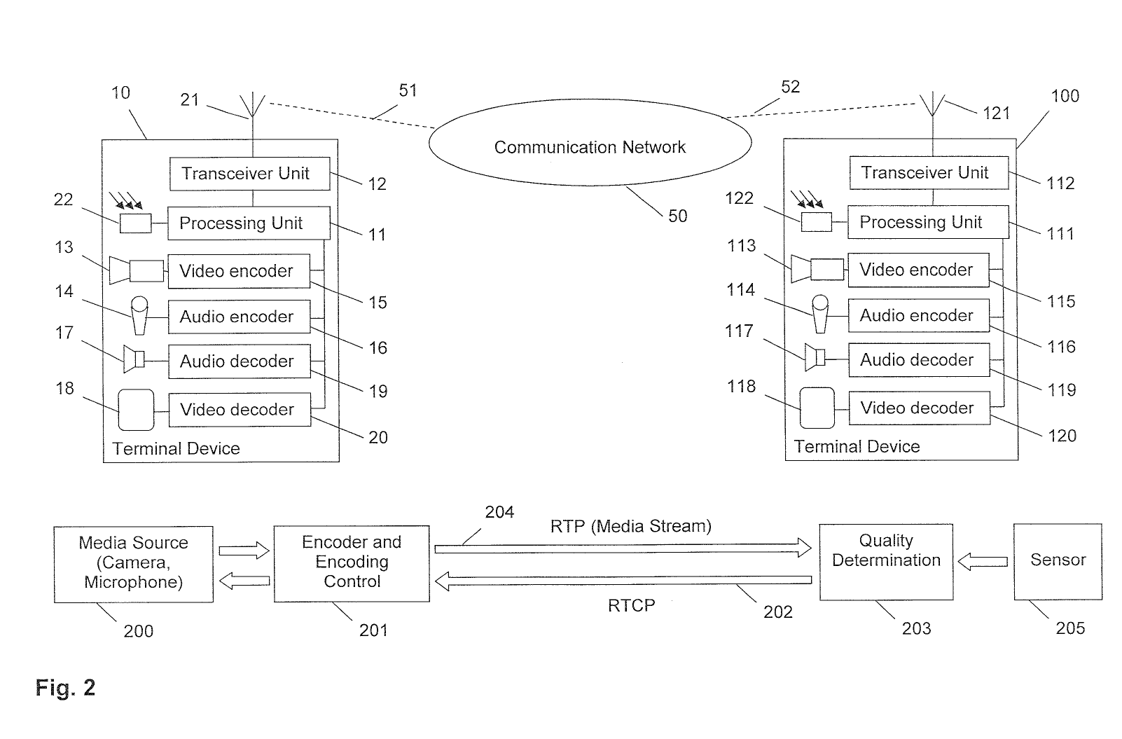

FIG. 2 shows a further communication system comprising a sending terminal device 10 which streams media data via the communication network 50 to a receiving terminal device 100. As described in connection with FIG. 1, the sending terminal device 10 captures media with the media source 200 in an environment of the sending terminal device 10. The captured media is encoded by the encoder 201 and sent as media stream 204 to the receiving terminal device 100. In the receiving terminal device 100 a quality of the communication channel between the sending terminal device 10 and the receiving terminal device 100 is determined by the quality determination 203 and sent back to the sending terminal device 10 via the real-time control protocol 202. Additionally, an environmental information relating to an environmental condition in an environment of the sending terminal device 100 is captured with a sensor 205. The sensor 205 may comprise for example a light sensitive sensor 122 delivering a light intensity level or the microphone 114 delivering a background noise level at the sending terminal device 100. The environmental information comprising for example the background noise level and/or the light intensity level, is sent together with the transmission quality via the real-time control protocol 202 to the sending terminal device 10. At the sending terminal device 10, the media encoding 201, for example the video encoder 15 and/or the audio encoder 16, are set or configured depending on the received environmental information. For example, if the receiving terminal device 100 is in a dark room, the strength of the colors can be reduced already at the sending terminal device 10 by adapting the video encoder 15 accordingly.

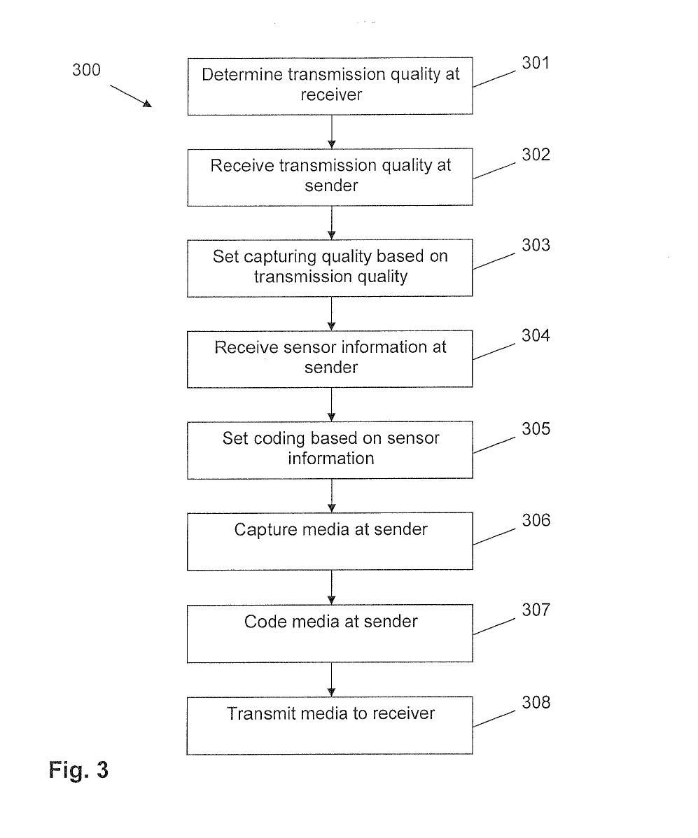

The above-described embodiments of the FIGS. 1 and 2 may be combined with each other. FIG. 3 shows a method 300 comprising corresponding method steps 301 to 308. In step 301, a transmission quality at a receiver, for example the receiving terminal device 100, is determined. The transmission quality relates to a communication channel established between two terminal devices, for example the sending terminal device 10 and the receiving terminal device 100. The determined transmission quality is sent back via the real-time control protocol 202 to the sending terminal device 10 and received in step 302 at the receiving terminal device 10. In step 303 a capturing quality for media sources is set at the sending terminal device 10 based on the received transmission quality. Furthermore, the receiving terminal device 100 determines an environmental information with the sensor 205 and sends this sensor information via the real-time control protocol 202 to the receiving terminal device 10. In step 304, this sensor information is received at the sending terminal device 10 and based on the sensor information a coding of the encoder 201, for example the video encoder 15 or the audio encoder 16, is set accordingly in step 305. Now, the media sources and the encoders of the sending terminal device 10 are configured and media is captured in step 306 and coded in step 307 with this configuration at the sending terminal device 10. The coded media is transmitted as a media stream via the real-time protocol 204 in step 308 to the receiving terminal device 100.

While exemplary embodiments have been described above, various modifications may be implemented in other embodiments. For example, the sensor information determined at the receiving terminal device 100 and send back to the sending terminal device 10 may not only be used to adapt the coding of media at the sending terminal device 10, but may also be used to adapt the capturing of media at the sending terminal device 10.

1-15. (canceled)

16. A method for operating a terminal device of a communication system, the terminal device comprising a capturing device for capturing media, wherein the terminal device is configured to transmit the captured media via a data communication connection of the communication system, the method comprising the steps of:
determining a transmission quality of the data communication connection, and
automatically setting a capturing quality of the capturing device depending on the determined transmission quality.

17. The method according to claim 16, wherein the transmission quality comprises at least one of a group consisting of:
a bandwidth of the data communication connection,
a data rate of the data communication connection,
a bit error rate of the data communication connection,
a packet loss rate of the data communication connection,
a jitter of the data communication connection, and
a data round trip time of the data communication connection.

18. The method according to claim 16, wherein the capturing device comprises a camera, wherein setting the capturing quality of the camera comprises at least one of a group consisting of:
setting a pixel resolution of the camera,
setting a frame rate of the camera,
setting a color depth of the camera, and
setting a contrast of the camera.

19. The method according to claim 16, wherein the capturing device comprises at least one microphone, wherein setting the capturing quality of the microphone comprises at least one of a group consisting of:
setting a sampling rate of an audio signal provided by the at least one microphone,
setting a sampling accuracy of an audio signal provided by the at least one microphone, and
setting a number of audio channels to be used, wherein each audio channel is associated with one of the at least one microphone.

20. The method according to claim 16, wherein the media comprises at least one of a group consisting of:
audible information captured in an environment of the terminal device, and
visible information captured in an environment of the terminal device.

21. The method according to claim 16, wherein transmitting the media comprises streaming the media via the data communication connection.

22. A method for operating a terminal device of a communication system, the terminal device comprising a capturing device for capturing media and a media coding device for coding the captured media, wherein the terminal device is configured to transmit the coded media via a data communication connection of the communication system to a further terminal device of the communication system, the method comprising the steps of:
receiving from the further terminal device environmental information relating to an environmental condition in an environment of the further terminal de-vice, and
automatically setting a coding parameter of the media coding device de-pending on the received environmental information.

23. The method according to claim 22, wherein the step of receiving the environmental information comprises receiving the environmental information via a real time control protocol established between the terminal device and the further terminal device.

24. The method according to claim 22, wherein the environmental information comprises at least one of a group consisting of:
a background noise level at the further terminal device, and
a light intensity level at the further terminal device.

25. The method according to claim 22, further comprising:
automatically setting a capturing quality of the capturing device depending on the received environmental information.

26. The method according to claim 25, wherein the capturing device comprises a camera, wherein setting the capturing quality of the camera comprises at least one of a group consisting of:
setting a pixel resolution of the camera,
setting a frame rate of the camera,
setting a color depth of the camera, and
setting a contrast of the camera.

27. The method according to claim 25, wherein the capturing device comprises at least one microphone, wherein setting the capturing quality of the microphone comprises at least one of a group consisting of:
setting a sampling rate of an audio signal provided by the at least one microphone,
setting a sampling accuracy of an audio signal provided by the at least one microphone, and
setting a number of audio channels to be used, wherein each audio channel is associated with one of the at least one microphone.

28. The method according to claim 22, wherein the media comprises at least one of a group consisting of:
audible information captured in an environment of the terminal device, and
visible information captured in an environment of the terminal device.

29. The method according to claim 22, wherein transmitting the media comprises streaming the media via the data communication connection.

30. A terminal device for a communication system, comprising:
a transceiver unit for establishing a data communication connection,
a capturing device for capturing media, and
a processing unit configured to transmit the captured media via the data communication connection, to determine a transmission quality of the data communication connection, and to automatically set a capturing quality of the capturing device depending on the determined transmission quality.

31. The terminal device according to claim 30, wherein the terminal device comprises at least one device of a group consisting of a portable battery powered de-vice, a mobile phone, a personal digital assistant, a mobile music player, a tablet computer, a laptop computer, a notebook computer, and a navigation system.

32. A terminal device for a communication system, comprising:
a transceiver unit for establishing a data communication connection,
a capturing device for capturing media,
a media coding device for coding the captured media, and
a processing unit configured to transmit the coded media via the data communication connection to a further terminal device of the communication system, to receive from the further terminal device environmental information relating to an environmental condition in an environment of the further terminal device, and to automatically set a coding parameter of the media coding device (depending on the received environmental information.

33. The terminal device according to claim 32, wherein the terminal device comprises at least one device of a group consisting of a portable battery powered de-vice, a mobile phone, a personal digital assistant, a mobile music player, a tablet computer, a laptop computer, a notebook computer, and a navigation system.

34. A terminal device for a communication system, comprising:
a transceiver unit for establishing a data communication connection,
a media playback device for playing back media,
a sensor for capturing environmental information relating to an environmental condition in an environment of the terminal device, and
a processing unit configured to receive media to be played back via the data communication connection, to play back the received media, to capture the environmental information with the sensor, and to transmit the environmental information via a real time control protocol to another terminal device of the communication system from which the media is received, for setting a coding parameter of a media coding device of the other terminal device depending on the environmental information.

35. The terminal device according to claim 34, wherein the terminal device comprises at least one device of a group consisting of a portable battery powered de-vice, a mobile phone, a personal digital assistant, a mobile music player, a tablet computer, a laptop computer, a notebook computer, and a navigation system.
